(19) United States
(12) Patent Application Publication
(10) Pub. No.: US 2019/0055972 A1
(43) Pub. Date: Feb. 21, 2019

(54) SURFACE FASTENER MEMBER AND METHOD FOR MANUFACTURING SAME

(71) Applicant: 3M INNOVATIVE PROPERTIES COMPANY, St Paul, MN (US)

(72) Inventors: Shuhei NISOGI, Tokyo (JP); Yoritsugu ITO, Tokyo (JP)

(73) Assignee: 3M Innovative Properties Company, St. Paul, MN (US)

(21) Appl. No.: 16/078,895

(22) PCT Filed: Mar. 10, 2017
(86) PCT No.: PCT/US2017/021822

§ 371 Date: Aug. 22, 2018

(30) Foreign Application Priority Data
Mar. 18, 2016 (JP) 2016-055962

(51) Int. Cl. F16B 5/07

(52) U.S. Cl. CPC F16B 5/07

(57) ABSTRACT

A male surface fastener member (1) is provided that has both good adhesiveness to polyolefin adhesives, and good mechanical strength and heat resistance. The surface fastener member (1) comprises an engaging part (12) having a surface (121) and a plurality of male engaging elements (122) provided on the surface, the surface fastener member (1) being made of a resin containing 60 to 95 mass % polyamide and 5 to 40 mass % polypropylene.

### TECHNICAL FIELD

The present invention relates to a surface fastener member, a method for manufacturing the same, and an automotive interior member comprising the surface fastener member.

### BACKGROUND ART

Surface fasteners have been widely used as means for fastening various articles to each other. In automobiles, for example, sheet members such as interior ceilings and headliners are fastened using surface fasteners.

Japanese Unexamined Patent Application Publication No. 2014-076210A discloses a surface fastener used to fasten sheet members used as automobile interior members. Japanese Unexamined Patent Application Publication No. 2005-145112A discloses a headliner to which a surface fastener (dual-lock member 3) is fastened. Japanese Unexamined Patent Application Publication No. 2005-193524A discloses a polyolefin sheet used as a sheet member used as an automobile interior member.

### SUMMARY OF INVENTION

The fastener member disclosed in Japanese Unexamined Patent Application Publication No. 2014-076210A enables the distance between members to be adjusted due to the presence of a height adjustment part, and allows for the suppression of rattling and noise caused by vibration and the like during use due to the fastener part and the height adjustment part being integrally molded. Meanwhile, hot melt adhesives are often favorably used to bond various types of parts to each other in automobiles. When such adhesives are used, hot melt polyolefin adhesives are sometimes used to bond the vehicle body and interior sheet members with surface fastener members for the sake of flame resistance, streamlining the automobile manufacturing process, reducing costs, and the like. In such cases, it is desirable for the surface fastener member used to anchor the automobile sheet members to exhibit good adhesiveness to the polyolefin adhesive.

Moreover, the engagement strength between surface fastener members is set comparatively high for surface fastener members for automotive use as described above in order to prevent dislodgement of the members during use. In other words, a comparatively large external force is placed on the engaging parts of surface fastener members when releasing the engagement therebetween. Surface fasteners are typically a combination of a male member comprising a male engaging element (such as a hook) and a female member comprising a female engaging element (such as a loop), or a combination of a pair of surface fastener members both having similar male engaging elements. Because the male engaging elements may be deformed or damaged if they are incapable of withstanding an external force, it is desirable for the male engaging elements to have good mechanical strength. It is also desirable for the male engaging elements to have good mechanical strength for the sake of yielding good engagement strength between the surface fastener members. Sheet members are sometimes removed from automobile bodies and replaced therein for the sake of vehicle maintenance. It is therefore desirable for engagement strength to not decrease through this repeated action of engagement and disengagement. In addition, automotive surface fastener members such as described above are often exposed to high-temperature (for example, about 90° C.) as the result of, for example, the temperature within the vehicle rising. It is therefore also desirable that surface fastener members for such uses have good heat resistance. It is also necessary to select a suitable olefin adhesive so that cohesive failure (failure within the adhesive layer; failure of the adhesive itself) does not occur upon exposure to high-temperature environments. It is desirable for the surface fastener member to exhibit good adhesiveness to the olefin adhesive.

An object of the invention according to the present application is to solve the problems described above and provide a male surface fastener member having both good adhesiveness to polyolefin adhesives, and good mechanical strength and heat resistance, as well as a method for manufacturing the same.

In one aspect of the present invention, a surface fastener member is provided that comprises an engaging part having a surface and a plurality of male engaging elements provided on the surface, the surface fastener member being made of a resin containing 60 to 95 mass % polyamide and 5 to 40 mass % polypropylene.

In another aspect of the present invention, a method is provided for manufacturing a surface fastener member according to the present invention. The method includes: preparing a material composition containing 60 to 95 mass % polyamide and 5 to 40 mass % polypropylene, and integrally molding the surface fastener member by injection molding the material composition.

In accordance with the present invention, it is possible to provide a surface fastener member having both good adhesiveness to polyolefin adhesives, and good mechanical strength and heat resistance, as well as a method for manufacturing the same.

### BRIEF DESCRIPTION OF THE DRAWINGS

FIG. 1 is a schematic perspective view of a surface fastener member according to one aspect of the present invention.

FIG. 2 is a schematic side view of the surface fastener member illustrated in FIG. 1.

FIG. 3 is a schematic top view of the surface fastener member illustrated in FIG. 1.

FIG. 4 is a schematic side view of a surface fastener member according to one aspect of the present invention.

FIG. 5 is a schematic side view of a surface fastener member according to one aspect of the present invention.

FIG. 6 is a schematic side view of a surface fastener member according to one aspect of the present invention.

FIG. 7 is a schematic side view of a surface fastener comprising a surface fastener member according to one aspect of the present invention.

FIG. 8 is an explanatory drawing of male engaging elements of surface fastener members manufactured in the examples and comparative examples.

FIG. 9 is an explanatory drawing of a method for measuring the adhesive properties of a male member with respect to a polyolefin adhesive.

### DESCRIPTION OF EMBODIMENTS

Hereafter follows a more detailed description with reference to the drawings as necessary with an object of illustrating typical embodiments of the present invention; however, the present invention is not limited to these embodiments and drawings. For convenience, elements having similar configurations or functions are identically labeled throughout the drawings. Unless otherwise noted, the various feature values in the present disclosure indicate values as measured according to the methods described in the Examples section of the present disclosure, or methods that would be understood as being equivalent thereto by a person skilled in the art.

One aspect of the present invention provides:

a surface fastener member comprising an engaging part having a surface and a plurality of male engaging elements provided on the surface,

the surface fastener member being made of a resin containing about 60 mass % to about 95 mass % polyamide and about 5 mass % to about 40 mass % polypropylene.

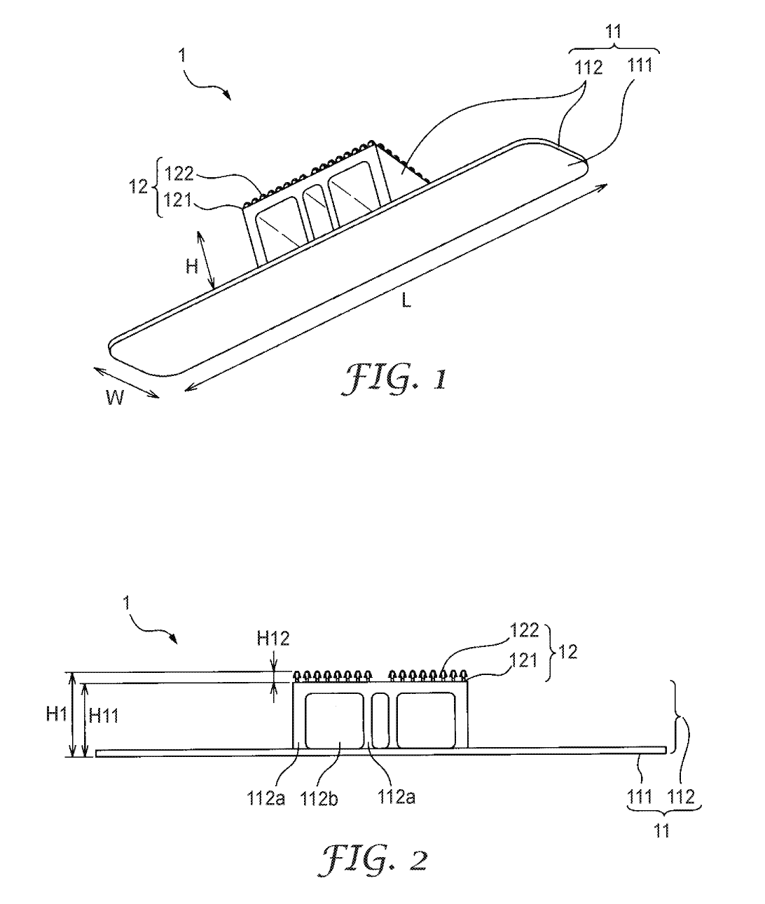

As seen in FIGS. 1 to 6, surface fastener members 1, 2, 3, 4 according to one embodiment of the present invention each comprise an engaging part 12 having a surface 121 and a plurality of male engaging elements 122 provided on the surface 121. In a typical embodiment, the surface fastener members 1, 2, 3, 4 comprise a base part 11 having a spacer section 112, and an engaging part 12 positioned above the spacer section 112. In a typical embodiment, the spacer section 112 comprises a cylindrical member 112a having a roughly cylindrical shape, and a cavity part 112b. In a typical embodiment, the base part 11 comprises an attachment surface 111 facing the engaging part 12 (more typically, facing the surface 121). At least part of the top surface of the spacer section 112 constitutes the surface 121 of the engaging part. The attachment surface 111 and the surface 121 may each be a roughly flat surface or a curved surface. As referred to herein with respect to the surface fastener member or a part thereof, the direction constituting the longitudinal direction of the attachment surface (the direction indicated by L in FIG. 1) is labeled the length direction, a direction parallel to the attachment surface and orthogonal to the length direction (the direction indicated by W in FIG. 1) is labeled the width direction, and the direction orthogonal to the attachment surface (the direction indicated by H in FIG. 1) is labeled the height direction.

In a typical embodiment, the surface fastener member is made from integrally molded resin. In this embodiment, the surface fastener member is intended as being an integrally molded article made of the same material throughout. In this embodiment, in other words, the surface fastener member is intended as not differing in material depending upon location. For example, the surface fastener member may be a two-colored integrally molded article the entirety of which is made of two types of material. In an especially typical embodiment, however, the surface fastener member is an integrally molded article constituted by the same material throughout. An integrally molded surface fastener member does not rattle, thereby yielding the advantages of allowing for the suppression of vibration-induced noise during use, and enabling the manufacturing process to be streamlined.

The resin making up the surface fastener member contains about 60 mass % to about 95 mass % polyamide and about 5 mass % to about 40 mass % polypropylene. Such a resin demonstrates good adhesiveness to polyolefin adhesives due to the contribution of the polypropylene, while exhibiting good mechanical strength and good heat resistance, for example, the ability to maintain good durability even in high-temperature environments of about 90° C., due to the contribution of the polyamide.

An automotive interior sheet member, which is one example of an object to which the surface fastener member of the present invention can be applied, is ordinarily a sheet of film or nonwoven fabric made from polyurethane, polyolefin, or the like. When the surface fastener member of the present invention is used for this purpose, the sheet and the surface fastener member are bonded by an adhesive. In a typical embodiment, the adhesive is a polyolefin adhesive (typically, a hot melt polyolefin adhesive). A heat-resistant polyolefin adhesive can be used as the polyolefin adhesive. Specifically, a polyolefin adhesive that has a heat resistance in heated environments of 90° C. of at least 2.0×10³ N/m², at least 4.0×10³ N/m², or up to 6.0×10³ N/m² can be advantageously used. In other words, a polyolefin adhesive that does not exhibit cohesive failure even when subjected to a load for 24 hours or longer in a heated environment of 90° C. at 2.0×10³ N/m² or less, 4.0×10³ N/m² or less, or 6.0×10³ N/m² or less. The resin of the present invention is capable of possessing good adhesiveness to polyolefin adhesives in particular due to the contribution of the resin's specific composition.

In order to obtain good toughness, the polyamide content of the resin should be at least about 60 mass %, or at least about 63 mass %. In order to obtain good adhesiveness to polyolefin adhesives, the polyamide content of the resin should be not greater than about 95 mass %, not greater than about 90 mass %, not greater than about 85 mass %, or not greater than about 80 mass %. In order to obtain good adhesiveness to polyolefin adhesives even in heated environments, the polyamide content is preferably at least about 65 mass %, not greater than about 72 mass %, or not greater than about 75 mass %.

In order to obtain good adhesiveness to polyolefin adhesives, the polypropylene content of the resin should be at least about 5 mass %, and preferably at least about 10 mass %, at least about 15 mass %, or at least about 20 mass %. In order to obtain good toughness, the polypropylene content of the resin should be not greater than about 40 mass %, or not greater than about 37 mass %. In order to obtain good adhesiveness to polyolefin adhesives even in heated environments, the polypropylene content is preferably at least about 25 mass % or at least about 28 mass %, and not greater than about 35 mass %.

Examples of polyamides include nylon 12, nylon 66, nylon 6, nylon 610, and copolymers thereof.

In addition to polyamide and polypropylene, the resin may further contain additives such as a filler.

Referring now to FIGS. 1 to 6, the attachment surface 111 is the surface that ends up facing the attached object. The shape of the attachment surface 111 may be set as appropriate according to purpose; for example, the surface may be a flat surface, curved surface, and the like, having a substantially rectangular shape or a shape obtained by cutting off the corners of a substantial rectangle (such as illustrated in FIG. 1). In order to improve adhesion to the adhesive, the attachment surface 111 may be roughened via a known method such as sandblasting during or after molding, or subjected to a primer treatment or the like.

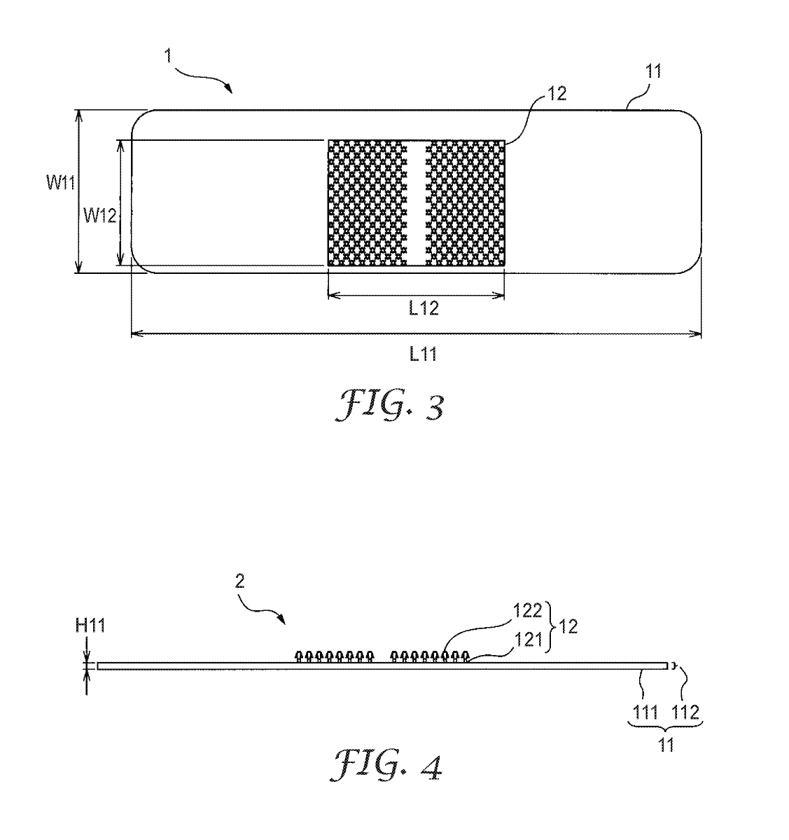

In an exemplary embodiment, as shown in FIGS. 1 to 6, the area of the surface 121 of the engaging part 12 is less than the area of the attachment surface 111. For example, as illustrated in FIG. 3, it is possible for the attachment surface 111 to have a length L11 and a width W11, and the engaging part 12 to have a length L12 less than length L11 and a width W12 less than width W11. In an exemplary embodiment, the engaging part 12 can be positioned in the centers of the width direction and length direction of the surface fastener member. However, the present invention is not limited to such an arrangement; the position, area, and the like of the engaging part 12 of the surface fastener member can be designed, as appropriate, according to the desired use for the surface fastener member.

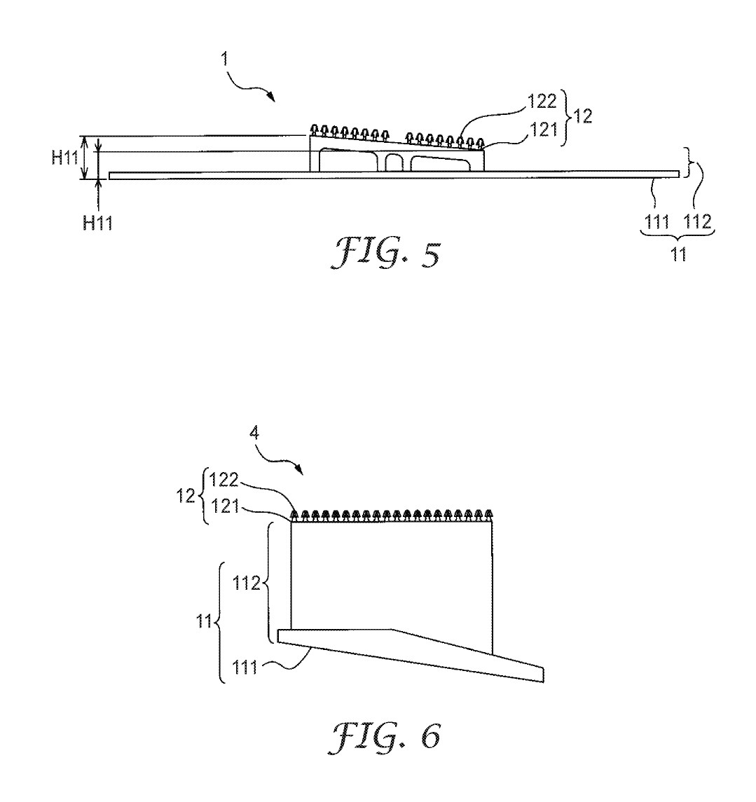

The spacer section 112 defines a height H11 from the attachment surface 111 to the surface 121 of the engaging part 12. The spacer section 112 can have many possible shapes, and any desired shape can be set, such as a shape having a cylindrical part as illustrated in FIGS. 1 and 2, or a plate-like shape as illustrated in FIG. 4. In an exemplary embodiment, the spacer section 112 is configured so that the attachment surface 111 and the surface 121 of the engaging part 12 are substantially parallel (as illustrated, for example, in FIGS. 2 and 4). Meanwhile, in other possible embodiments as illustrated in FIGS. 5 and 6, the spacer sections 112 of surface fastener members 3, 4 can be configured so that the attachment surface 111 and the surface 121 are slanted (i.e., not parallel) with respect to one another. FIG. 5 illustrates an example of an embodiment in which the slant direction is the longitudinal direction of a surface fastener member 3, and FIG. 6 illustrates an example of an embodiment in which the slant direction is the width direction of a surface fastener member 4. Any slant angle can be set according to the desired purpose; for example, the desired gap distance between the automobile body and the sheet member.

In an exemplary embodiment, the height H11 of the spacer section 112 can be at least about 0.5 mm, at least about 5 mm, or at least about 10 mm, and not greater than about 200 mm, not greater than about 50 mm, not greater than about 30 mm, or not greater than about 20 mm. If the attachment surface 111 and the surface 121 are not parallel, the height H11 may vary as appropriate within the abovementioned range depending on location.

The engaging part 12 comprises a surface 121 and a plurality of male engaging elements 122 provided on the surface 121. The plurality of male engaging elements 122 of the engaging part 12 may be arranged on the surface 121 in various manners as desired. In an exemplary embodiment, the plurality of male engaging elements 122 may be arrayed at constant pitches in each of the length direction and width direction, of the surface fastener member, and may form a regular pattern such as a lattice or staggered pattern.

In an exemplary embodiment, the density of the male engaging elements 122 per 1 square centimeter of the surface 121 of the engaging part 12 is at least about 10, at least about 20, or at least about 30 in order to obtain good engagement strength, and not more than about 65, not more than about 55, or not more than about 45 in order to streamline the manufacturing process and equipment.

A variety of shapes for the male engaging elements 122 are possible; examples include shapes combining a shaft part constituted by a columnar member that is cylindrical, rectangular prismatic, hexagonal prismatic, or the like, and an apex part that is disc-shaped, mushroom-shaped, hook-shaped, wedge-shaped, arrowhead-shaped, or the like. Such an apex part is capable of better mechanically engaging with the engagement surface of another surface fastener member (a female member comprising, for example, loops as female engaging elements) with which the surface fastener member of the present invention is combined, and offers the advantage of facilitating engagement and release.

In an exemplary embodiment, the height H12 of the male engaging elements 122 is at least about 0.5 mm, at least about 0.7 mm, or at least about 1.0 mm in order to good engagement strength, and not greater than about 3.0 mm, not greater than about 2.5 mm, or not greater than about 2.0 mm in order to improve the mechanical strength of the male engaging elements 122.

In an exemplary embodiment in which the male engaging elements 122 comprise shaft parts and apex parts, the major axis length of the shaft part when the surface fastener member is viewed from the height direction may be in a range from about 0.4 mm to about 1.0 mm or from about 0.5 mm to about 0.7 mm, and the amount to which the apex parts project over the surface (i.e., the distance from the outer edges of the shaft parts to the outer edges of the apex parts when the male engaging elements 122 are viewed from the height direction) may be in a range from about 0.2 mm to about 1.0 mm or from about 0.3 mm to about 0.5 mm. Various others shapes and dimensions are possible for the male engaging elements 122 as desired, and any shapes and dimensions known to persons skilled in the art are acceptable. Embodiments of male engaging elements known to persons skilled in the art are disclosed, for example, in Japanese Unexamined Patent Application Publication No. 2014-76210.

In an exemplary embodiment, the height H1 of the surface fastener member can be at least about 1.0 mm, at least about 5.5 mm, or at least about 11 mm, and not greater than about 203 mm, not greater than about 53 mm, not greater than about 33 mm, or not greater than about 22 mm.

In an exemplary embodiment, the length L11 of the attachment surface 111 is at least about 10 mm, at least about 15 mm, or at least about 20 mm in order to suitably anchor the surface fastener member to the attached object, and not greater than about 200 mm, not greater than about 150 mm, or not greater than about 100 mm in order to facilitate designing a surface fastener member arrangement matching the shape of the attached object.

In an exemplary embodiment, the width W11 of the attachment surface 111 is at least about 10 mm, at least about 15 mm, or at least about 18 mm in order to suitably anchor the surface fastener member to the attached object, and not greater than about 200 mm, not greater than about 150 mm, or not greater than about 100 mm in order to yield good convenience of use by not requiring an unduly large amount of force to release engagement.

In order to suitably anchor the surface fastener member to the attached object, the area of the attachment surface 111 can be at least about 1500 mm², at least about 1800 mm², or at least about 2000 mm².

In an exemplary embodiment, the length L12 of the engaging part 12 is at least about 5 mm or at least about 10 mm in order to obtain good engagement strength, and not greater than about 100 mm or not greater than about 80 mm in order to yield good convenience of use by not requiring an unduly large amount of force to release engagement.

In an exemplary embodiment, the width W12 of the engaging part is at least about 5 mm or at least about 10 mm in order to obtain good engagement strength, and not greater than about 100 mm or not greater than about 80 mm in order to facilitate engagement and disengagement between surface fastener members.

### Method for Manufacturing Surface Fastener Member

Another aspect of the present invention provides:

a method for manufacturing the surface fastener member according to the previously described aspect of the present invention, the method including:

preparing a material composition containing about 60 to about 95 mass % polyamide and about 5 to about 40 mass % polypropylene, and

integrally molding the surface fastener member by injection molding the material composition.

The material composition can be prepared by adding the polyamide and polypropylene, as well as the filler if one is used, followed by melting and mixing the ingredients.

Next, the material composition is injection molded. Injection molding can be performed using, for example, the mold comprising a sliding mechanism disclosed in Japanese Unexamined Patent Application Publication No. 2014-076210. Injection molding can be performed via insert molding, two-color molding, or the like. Using integrally molding facilitates post-molding removal even when the male engaging elements have high mechanical strength and resist elastic deformation, thereby facilitating the manufacture of a surface fastener member of superior engagement strength.

### Applying the Surface Fastener Member

In an exemplary embodiment, the surface fastener member comprises an attachment surface facing the engaging part, and a sheet member (automobile interior sheet member) is anchored on the attachment surface. In an exemplary embodiment, the present invention provides an automotive interior member comprising a surface fastener member and a sheet member. In an exemplary embodiment, the attachment surface of the surface fastener member and the sheet member are bonded using an olefin adhesive.

Turning now to FIG. 7, a surface fastener member 1 according to the present invention can be used as a male member, and can be combined with any other female member 5 to form a surface fastener 6. The female member 5 need only comprise a female engaging element capable of engaging with the male engaging element of the surface fastener member according to the present invention. In an exemplary embodiment, the female engaging elements are loops. In an exemplary embodiment, a male member constituted by the surface fastener member of the present invention is bonded to a first substrate, a female member constituted by a different surface fastener member is bonded to a second substrate, and the male member and the female member can be mechanically engaged, thereby engaging the first substrate and the second substrate. For example, if the first substrate is a sheet member for an interior ceiling or the like, and the second member is a vehicle body, the interior ceiling sheet member or the like can be anchored to the vehicle body using the surface fastener. Anchoring the surface fastener member via an adhesive to the sheet member at the attachment surface 111 facing the engaging part 12 eliminates the need to mold a structure for anchoring the surface fastener member to the sheet member, thereby allowing the shape of the sheet member to be simplified and the weight of the sheet member to be reduced. Such an arrangement also yields the advantage of not producing noise that could be produced by sliding between the surface fastener member and the sheet member.

The attached object (for example, an automobile body or interior member) and the male and female members are bonded by applying adhesive to at least one attachment surface of the attached object or male and female members, then pressing together the attached object and male or female member at a pressure of, for example, 5000 N/m². The adhesive will ordinarily have a final thickness of about 0.5 mm to about 2.0 mm.

In an exemplary embodiment, the surface fastener member of the present invention can have a peel strength following bonding to the attachment object of, for example, about 2.0×10□ N/mm² or greater, about 2.5×10□ N/mm² or greater, or about 3.0×10□ N/mm² or greater due to the contribution of the good adhesiveness thereof to the polyolefin adhesive. Peel strength is as measured according to a tensile test performed at a strain rate of 300 mm/min in a surface-perpendicular direction.

### EXAMPLES

An exemplary embodiment of the present invention will now be described in further detail using examples; however, the present invention is not limited by these examples.

### 1. Mold for Injection Molding

Injection molding was performed using a slide mold similar to that disclosed in Japanese Unexamined Patent Application Publication No. 2014-076210.

### 2. Female Member

A SJ9108 loop fastener manufactured by 3M Japan was cut to 35 mm length×17 mm width.

### 3. Manufacturing Surface Fastener Member Constituting Male Member

### Example 1

A material composition was prepared by mixing resin materials at the weight ratios shown in Tables 1 and 2. Nylon 66 was used as the polyamide in Examples 1 to 4 and Comparative Example 2, and nylon 6 in Example 5.

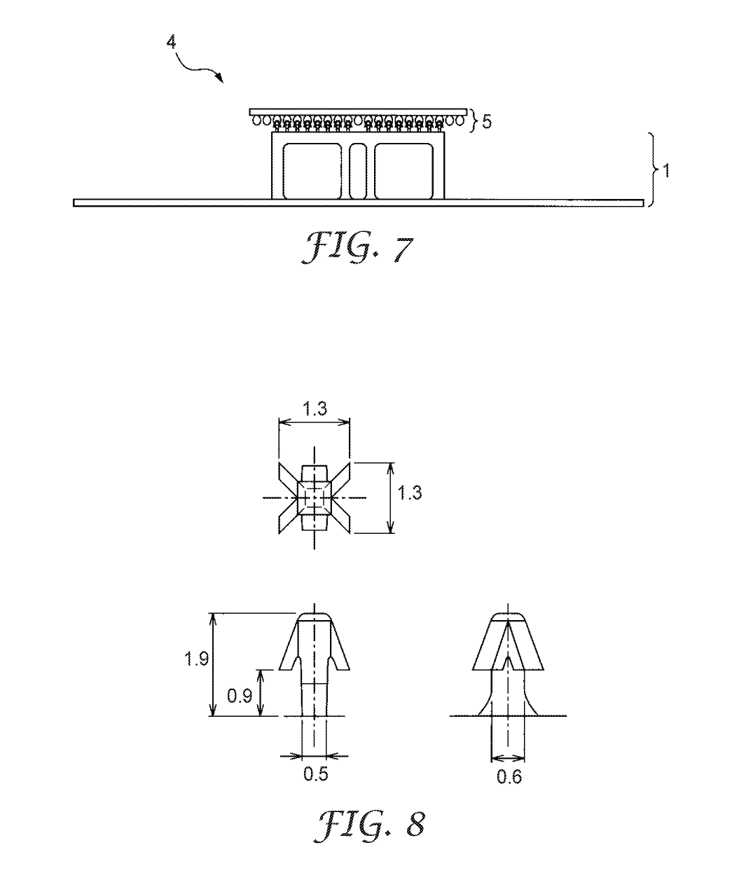

The injection molding mold was filled with the material composition, and a surface fastener member having a rough shape like that illustrated in FIGS. 1 to 3 was manufactured. The engaging part comprised male engaging elements having the shape illustrated in FIG. 8 at a density of 30/square inch (for a total of 150 across the male member as a whole). The numbers in FIG. 8 are in mm. The attachment surface had the shape of a 92 mm long by 26.5 mm wide rectangle from which the corners have been cut in a rounded shape (attachment surface area: 2400 mm²), the size of the surface of the engaging part provided in the center of the attachment surface was 28 mm long by 20 mm wide, and the height of the surface fastener member was 16 mm (resulting in a spacer section height of 14.1 mm).

### Examples 2 to 5, Comparative Example 1, and Comparative Example 2

A surface fastener member was manufactured as in Example 1, except that the resin composition was altered as shown in Tables 1 and 2.

### Performance Evaluation

### 1. Adhesive Properties of Male Member to Polyolefin Adhesive

### (1) At Ambient Temperature

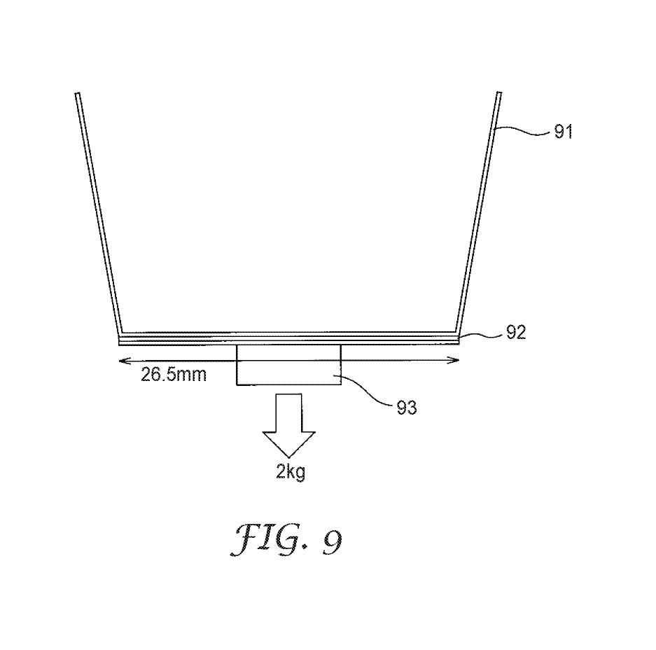

Adhesive properties were measured according to the method shown in FIG. 9. A 26.5 mm wide by 92 mm long strip of polypropylene hot melt adhesive was applied to the center of the length and width directions of a 300 mm long by 100 mm wide polypropylene sheet 91 (thickness: 0.5 mm), an attachment surface (width 26.5 mm×length 92 mm) of a male member 93 was positioned over and placed facing the adhesive so that the entirety of the attachment surface was bonded to the adhesive, and the whole was compressed to bond the male member to the polypropylene sheet. The final thickness of the adhesive was about 1 mm. That portion of the polypropylene sheet to which the polyolefin hot melt adhesive was not applied was anchored, threads were passed through the spacer sections of the male member, and a 2 kg weight was suspended from the strings to confirm whether interface debonding occurred between the male member and the polyolefin hot melt adhesive.

### (2) At Elevated Temperatures

A male member was attached to a polypropylene sheet (thickness: 0.5 mm) using a polyolefin hot melt adhesive as in (1). The presence or lack of interface bonding between the male member and the polyolefin hot melt adhesive was then confirmed by suspending a 2 kg weight according to a similar procedure as in (1), except that the temperature was 90° C. instead of ambient temperature.

### 2. Fastener Performance

(1) Stem Breakage Following Debonding from Female Member

The engaging elements of the male and female members were manually engaged, then manually disengaged, and the presence of breakage of the male engaging element (stems) of the male member was visually confirmed and evaluated according to the following criteria.

Number of broken stems: less than 5% (less than 7 stems): Excellent; equal to or greater than 5% (equal to or greater than 7 stems): Poor

### (2) Heat Resistance

The liner was then removed from the female member, and a tape surface was bonded to a T-block surface (primer-treated using N200-NT, manufactured by 3M Japan). The male member and the female member were engaged in a 480 mm² region. Next, the portions of the base parts of the male member not disposed over the engaging part where anchored so that the surface fastener faced downward, a 2 kg weight was suspended from the T-block, and the whole was heated at 115° C. for 168 hours and checked to see if engagement between the male and female members was maintained.

Results are shown in Tables 1 and 2.

TABLE 1

| | | | | Comparative | Comparative |
|---|---|---|---|---|---|
| | | Example 1 | Example 2 | Example 1 | Example 2 |
| Polyamide/polypropylene | | 72/28 | 65/35 | 0/100 | 100/2 |
| Mass ratio | | | | | |
| 72/28 | | | | | |
| Adhesive | At ambient | No interface | No interface | No interface | Interface |
| properties | temperature | debonding | debonding | debonding | debonding |
| | | | | | present |
| | At elevated | No interface | No interface | No interface | — |
| | temperature | debonding | debonding | debonding | |
| Fastener | Stem | Excellent | Excellent | Poor | Excellent |
| performance | breakage | | | | |
| | Heat | Maintained | Maintained | Maintained | Maintained |
| | resistance | engagement | engagement | engagement | engagement |
| | | for 168 hours | for 168 hours | for 168 hours | for 168 hours |
| | | after start | after start | after start | after start |

TABLE 2

| | | Example 3 | Example 4 | Example 5 |
|---|---|---|---|---|
| Polyamide/polypropylene | | 80/20 | 87/13 | 70/30 |
| Mass ratio | | | | |
| Adhesive | At ambient | No interface | No interface | No interface |
| properties | temperature | debonding | debonding | debonding |
| | At elevated | Interface | Interface | No interface |
| | temperature | debonding present | debonding present | debonding |
| Fastener | Stem | Excellent | Excellent | Excellent |
| performance | breakage | | | |
| | Heat | Maintained | Maintained | Maintained |
| | resistance | engagement for | engagement for | engagement for |
| | | 168 hours after | 168 hours after | 168 hours after |
| | | start | start | start |

It is apparent from the results shown in Tables 1 and 2 that the combination of polyamide and polypropylene imparted the surface fastener member with both good adhesiveness to polyolefin adhesives and good mechanical strength and heat resistance.

The surface fastener member of the present invention can be advantageously applied to uses such as anchoring interior sheet members such as interior ceilings, headliners, or sheets (chair coverings) to a body such as a vehicle body or body sheet.

1. A surface fastener member comprising an engaging part having a surface and a plurality of male engaging elements provided on the surface, the surface fastener member being made of a resin containing 60 to 95 mass % polyamide and 5 to 40 mass % polypropylene.

2. The surface according to claim 1, wherein the male engaging elements of the engaging part are provided at a density of from 10 to 650 per 1 square centimeter.

3. The surface fastener member according to claim 1, further comprising:
a base part having a spacer section; and
the engaging part positioned above the spacer section.

4. The surface fastener member according to claim 1, further comprising an attachment surface facing the engaging part and anchored to a sheet member by the attachment surface.

5. An automotive interior member comprising the surface fastener member according to claim 4 and a sheet member, the attachment surface of the surface fastener member and the sheet member being bonded using an olefin adhesive.

6. A method for manufacturing the surface fastener member according to claim 1 to the method comprising:
preparing a material composition containing 60 to 95 mass % polyamide and 5 to 40 mass % polypropylene, and
integrally molding the surface fastener member by injection molding the material composition.

7. The surface fastener member according to claim 2, further comprising:
a base part having a spacer section; and
the engaging part positioned above the spacer section.

8. The surface fastener member according to claim 2, further comprising an attachment surface facing the engaging part and anchored to a sheet member by the attachment surface.

9. The surface fastener member according to claim 3, further comprising an attachment surface facing the engaging part and anchored to a sheet member by the attachment surface.

10. The surface fastener member according to claim 7, further comprising an attachment surface facing the engaging part and anchored to a sheet member by the attachment surface.

11. An automotive interior member comprising the surface fastener member according to claim 8 and a sheet member, the attachment surface of the surface fastener member and the sheet member being bonded using an olefin adhesive.

12. An automotive interior member comprising the surface fastener member according to claim 9 and a sheet member, the attachment surface of the surface fastener member and the sheet member being bonded using an olefin adhesive.

13. An automotive interior member comprising the surface fastener member according to claim 10 and a sheet member, the attachment surface of the surface fastener member and the sheet member being bonded using an olefin adhesive.

14. A method for manufacturing the surface fastener member according to claim 2, the method comprising:
preparing a material composition containing 60 to 95 mass % polyamide and 5 to 40 mass % polypropylene, and
integrally molding the surface fastener member by injection molding the material composition.

15. A method for manufacturing the surface fastener member according to claim 3, the method comprising:
preparing a material composition containing 60 to 95 mass % polyamide and 5 to 40 mass % polypropylene, and
integrally molding the surface fastener member by injection molding the material composition.

16. A method for manufacturing the surface fastener member according to claim 4, the method comprising:
preparing a material composition containing 60 to 95 mass % polyamide and 5 to 40 mass % polypropylene, and
integrally molding the surface fastener member by injection molding the material composition.

17. A method for manufacturing the surface fastener member according to claim 7, the method comprising:
preparing a material composition containing 60 to 95 mass % polyamide and 5 to 40 mass % polypropylene, and
integrally molding the surface fastener member by injection molding the material composition.

18. A method for manufacturing the surface fastener member according to claim 8, the method comprising:
preparing a material composition containing 60 to 95 mass % polyamide and 5 to 40 mass % polypropylene, and
integrally molding the surface fastener member by injection molding the material composition.

19. A method for manufacturing the surface fastener member according to claim 9, the method comprising:
preparing a material composition containing 60 to 95 mass % polyamide and 5 to 40 mass % polypropylene, and
integrally molding the surface fastener member by injection molding the material composition.

20. A method for manufacturing the surface fastener member according to claim 10, the method comprising:
preparing a material composition containing 60 to 95 mass % polyamide and 5 to 40 mass % polypropylene, and
integrally molding the surface fastener member by injection molding the material composition.
